(19) United States
(12) Patent Application Publication
(10) Pub. No.: US 2012/0241699 A1
(43) Pub. Date: Sep. 27, 2012

(54) MECHANICAL ASSEMBLY WITH PULLEY AND ROPE, AND CHAIN TYPE HOIST COMPRISING SUCH A MECHANICAL ASSEMBLY

(75) Inventors: Philippe Vigneau, Seysses (FR); David Sinelle, Le Temple (FR)

(73) Assignee: AIRBUS OPERATIONS (incorp. as a S.A.S.), Toulouse (FR)

(21) Appl. No.: 13/386,982

(22) PCT Filed: Jul. 26, 2010
(86) PCT No.: PCT/FR2010/051570

§ 371 Date: May 31, 2012

(30) Foreign Application Priority Data
Jul. 28, 2009 (FR) 0955263

(51) Int. Cl. B66D 3/16

(52) U.S. Cl. 254/359

(57) ABSTRACT

A mechanical assembly, including: a control pulley including a plurality of compartments each delimited at least partially by a surface forming a stop, and a transmission mechanism including stop devices configured to engage in the compartments, such that actuation of the transmission mechanism will cause rotation of the control pulley, due to the stop devices engaged in the compartments coming up against the corresponding surfaces forming a stop. The transmission mechanism further includes a control rope made of a natural and/or synthetic material fitted with the stop devices.

### TECHNICAL FIELD

This invention relates to the field of handling equipment and relates more particularly to a mechanical assembly comprising a pulley and a rope provided with stop devices, and a chain or cable type hoist or pulling equipment comprising such a mechanical assembly.

### STATE OF PRIOR ART

Large and heavy objects need to be moved vertically during many industrial processes, and particularly during assembly processes.

For example, this is the case in the field of aeronautics in which the assembly of an aircraft comprises a number of load lifting operations, for example a high-lift device (trailing edge flap, leading edge flap, engine cowling, etc.) in order to mount it on one of the wings.

Operations to lift such objects are usually done using a chain or cable type hoist.

FIG. 1 shows an example chain hoist used to perform such operations.

The hoist 1 comprises a control device 10 and a lifting device 20 coupled to each other at a housing 2. The housing 2 is normally attached to a hoist crab 3 through a suspension hook 4. The crab 3 may be moved along a monorail 5 or a jib crane to position the hoist 1 at a given location.

The control device 10 of the hoist comprises a control chain 11 that engages in a control pulley located in the housing 2. The lifting device 20 comprises a lifting chain 21 to which a lifting hook 22 is attached. The lifting chain 21 engages in a lifting pulley itself located in the housing 2. Said chains 11, 21 may be link or roller chains and are usually made of steel.

Said pulleys are mounted fixed in translation on the housing 2 and coupled to each other through a torque reduction gear. Said reduction gear reduces the torque at the control pulley and transmits it to the lifting pulley.

Furthermore, it is known that a cable hoist is different from a chain hoist essentially in the lifting device. The lifting device in a cable hoist usually comprises a lifting drum on which a lifting cable is wound. The lifting cable, usually made of steel, is fixed to the drum at one end while a lifting hook is fixed to the second end. The cable hoist may be actuated by a chain control device exactly the same as that described above. The drum is then coupled to the control pulley through a reduction gear so as to be driven in rotation by the control pulley.

Note that this type of hoist is not the same as block and tackle which comprises two pulley blocks, one of which is fixed and the other is free to move, each comprising one or several pulleys around which a single rope passes. One of the ends of the rope is fixed to one of the blocks and a lifting hook is fixed to the mobile block. When a tension force is applied to the rope, the mobile block moves closer to the fixed block and thus lifts the load attached to the lifting hook.

However, chain or cable hoists like those described above have the disadvantage that when the control chain is activated, it can oscillate and rub against and/or strike the object to be lifted or a nearby object and therefore cause damage to said object.

More generally, there are several mechanical assemblies comprising a control pulley and a control chain cooperating by engaging with said pulley to drive said pulley in rotation. These mechanical assemblies are not necessarily suspended. However, the control chain may still oscillate and strike and/or rub against an object located nearby. Therefore, said object may be damaged in a particularly prejudicial manner.

### PRESENTATION OF THE INVENTION

The main purpose of the invention is to provide a mechanical assembly comprising a control pulley driven in rotation by a control rope, adapted to reduce the risks of deterioration of an object located nearby due to the contact with the control rope.

To achieve this, the purpose of the invention is a mechanical assembly comprising:
a control pulley comprising a plurality of compartments each delimited at least partially by a surface forming a stop, and
transmission means comprising stop devices designed to engage in said compartments, such that actuation of said transmission means will cause rotation of said control pulley, due to the fact that the stop devices engaged in the compartments come up against the corresponding surfaces forming a stop.

According to the invention, the transmission means comprise a control rope made of natural and/or synthetic material fitted with said stop devices.

A compartment means a space delimited by a surface of the control pulley including said surface forming a stop, in which a stop device can be engaged.

Preferably, said compartments are located at the circumferential surface of the control pulley. The circumferential surface of the control pulley is the surface that delimits the external periphery of the pulley.

A rope means a long element with a circular or polygonal cross-section, for example rectangular, square, trapezoidal or with an arbitrary number of sides.

Thus, regardless of what the mechanical assembly is used for, the control rope can oscillate or it can be moved approximately orthogonal to its longitudinal axis and thus strike and/or rub against an object located nearby.

However, unlike examples in prior art described above, said mechanical assembly according to the invention reduces the risks of degradation of said object due to contact with the control rope.

Due to the fact that said control rope is made from a natural and/or synthetic material, it has a lower density and greater flexibility than steel chains usually used in cooperation with a pulley, for example the chain used in the hoist in the example in prior art described above.

Thus, when the control rope according to the invention strikes said object, the kinetic energy acquired by the rope during its movement and transmitted to the object at the time of the shock is significantly less than the energy present in the case of a steel chain. Consequently, the object is only slightly damaged or not at all damaged at the time of such a shock.

Similarly, risks of degradation of said object due to friction with the control rope are also reduced or even eliminated. The intensity of the contact force applied by the rope in contact with the object is significantly less than for steel chains because the density and hardness of the control rope are lower and it is also more flexible. Therefore the harmful effects of such friction from the control rope on said object are significantly reduced or even eliminated.

Thus, the risks of damage to an object to be lifted or a nearby object when the control rope according to the invention rubs against or strikes said object are significantly reduced.

Preferably, each compartment is at least partially delimited by two surfaces forming a stop. The surfaces forming the stop are approximately orthogonal to the circumferential axis of the control pulley.

The material from which said control rope is made may be chosen from among polyamides, polyesters, polypropylenes and polyolefins.

The control rope is formed from an assembly of threads. The threads may be twisted or braided and may be assembled so as to form several strands. The rope is then formed from the assembly of strands with each other.

Preferably, the threads will be polyamide. They may form several strands, preferably an even number, for example four. The rope diameter may be about 7 millimetres at rest and about 6 millimetres under tension.

Advantageously, said stop devices are arranged or formed along the control rope according to the invention and they cannot be moved along it.

Advantageously, said stop devices are made from a material chosen from among rubber and plastic. Thus for the same reasons as described above, any risk of degradation of the object to be lifted or a nearby object due to contact with one of the stop devices is significantly reduced. Said stop devices are preferably made from rigid PVC thermoplastic and their minimum resistance to tensile rupture is of the order of 5 daN/mm².

Preferably, the external shape of said stop devices is a cylinder of revolution, of which the axis of revolution coincides approximately with the longitudinal axis of the control rope. The stop devices may be formed by machining. The diameter of the stop devices may be of the order of 20 millimetres and the length may be of the order of 20 millimetres.

Preferably, each of said stop devices is fixed to said control rope by attachment means, said attachment means extending through said control rope. Preferably, the attachment means extend along an axis approximately orthogonal to the longitudinal axis of the control rope. When the control rope comprises several strands, said attachment means may extend in a space made by local separation of two groups of strands each comprising the same number of strands.

Advantageously, said attachment means are located inside the external contour of each stop device. An external contour means the external surface delimiting the stop device. Thus attachment means cannot come into contact with the object to be lifted or a nearby object. Any risk of degradation is thus eliminated.

According to the preferred embodiment, each of said stop devices is formed from two half shells assembled to each other by said attachment means, said attachment means inducing squeezing of said control rope between said half shells. Said attachment means may then comprise a screw and a nut. The screw may then extend through the rope, preferably between two groups of strands forming the rope. The attachment means induce a squeezing of said rope, indirectly through the two half-shells.

According to one alternative embodiment, each of said stop devices is formed from a single piece by injection moulding. The attachment means may then consist of an insert placed inside the stop device, so as to pass through the control rope.

Alternately to the stop devices according to the invention described above, the stop devices may be knots formed by said control rope. For example, the knots may be in the known form of an overhand knot, a figure-of-eight knot or any other form such that the knots can engage in said compartments in the control pulley and cooperate with said surfaces forming stop.

Preferably, said control pulley comprises a groove extending between said compartments at the circumferential surface of said pulley, said groove being designed to house said control rope.

The invention also applies to a lifting equipment that can be suspended comprising a lifting device designed to lift an object.

The lifting equipment comprises a mechanical assembly according to any one of the previous characteristics, said control pulley being coupled to said lifting device such that rotation of the control pulley actuates the lifting device.

Thus, for the same reasons as above, any risk of degradation of the object to be lifted or a nearby object due to shocks and friction with the lifting rope or associated stop devices is eliminated.

Said lifting device may comprise an assembly formed from a lifting pulley coupled to said control pulley and comprising a plurality of compartments, and a lifting rope made of a natural and/or synthetic material provided with stop devices designed to engage in said compartments of the lifting pulley. The lifting pulley, the lifting rope and the associated stop devices may have any of the characteristics described above with reference to the control rope according to the invention and the associated stop devices. This eliminates all risk of degradation of the object to be lifted or a nearby object due to shocks and friction with the lifting rope or associated stop devices.

Alternately, the lifting device may comprise an assembly formed from a lifting drum and a lifting rope made of a natural and/or synthetic material, one end of said lifting rope being fixed to said drum. The lifting rope may have any of the characteristics described above with reference to the control rope according to the invention. This eliminates all risk of degradation of the object to be lifted or a nearby object due to shocks and friction with the lifting rope.

According to one variant embodiment, said lifting device may comprise a lifting pulley and a lifting chain, said lifting chain engaging in said lifting pulley. In this case, the characteristics of the lifting pulley and the lifting chain are familiar to those skilled in the art.

Alternately, said lifting device may comprise a lifting drum and a lifting cable, one end of said lifting cable being fixed to said drum. The cable refers to a rope entirely formed from an assembly of metallic wires, for example steel wires. In this case, the characteristics of the lifting drum and the lifting cable are familiar to those skilled in the art.

Furthermore, said control pulley may be mounted to be fixed in translation relative to said lifting pulley or said lifting drum.

Other advantages and characteristics of the invention will become clear from the detailed non-limitative description given below.

### BRIEF DESCRIPTION OF THE DRAWINGS

We will now describe embodiments of the invention as non-limitative examples with reference to the appended drawings in which:

FIG. 1 already described, is a perspective view of a part of a hoist according to prior art;

FIG. 2 is a perspective view of a control pulley for the lifting equipment according to the preferred embodiment of the invention;

FIG. 3 is a diagrammatic longitudinal sectional view of the control rope according to the invention, provided with a plurality of stop devices;

FIG. 4 is a perspective view of the control pulley shown in FIG. 2 on which the control rope shown in FIG. 3 partially winds;

FIG. 5 is a perspective view of part of the control pulley, in which a compartment houses a stop device according to the preferred embodiment;

FIG. 6 is a perspective view of a portion of the control rope according to the invention provided with a stop device;

FIG. 7A is a sectional view along a first longitudinal plane of said part of the control rope and said stop device as shown in FIG. 6;

FIG. 7B is a sectional view along a second longitudinal plane orthogonal to the first longitudinal plane of said part of the control rope and said stop device shown in FIG. 6.

### DETAILED PRESENTATION OF A PREFERRED EMBODIMENT

The lifting equipment according to the invention is of the chain or cable hoist type. Like the chain hoist described with reference to the example of prior art, the lifting equipment is designed to be suspended.

It comprises a suspension means, for example a hook that can be used to suspend it from a hoist support crab. The crab may be moved along a monorail or a jib crane to position the lifting equipment at the required location.

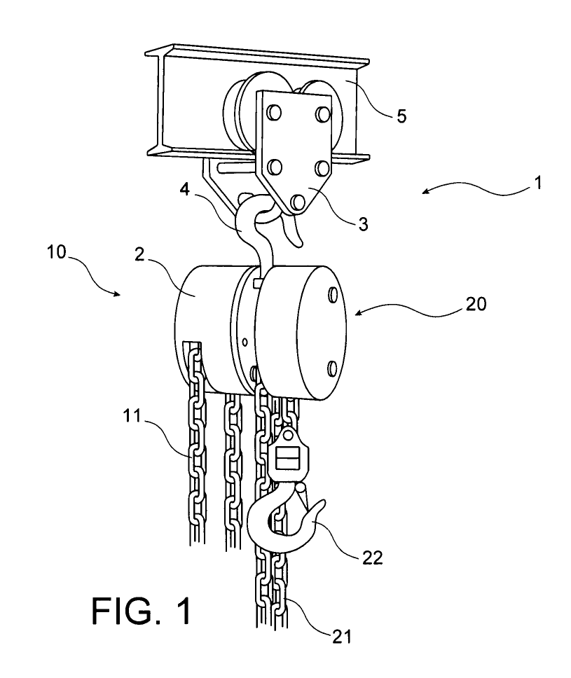

The lifting equipment comprises a lifting device designed to lift an object, similar to or identical to that described with reference to the example of prior art and shown in FIG. 1.

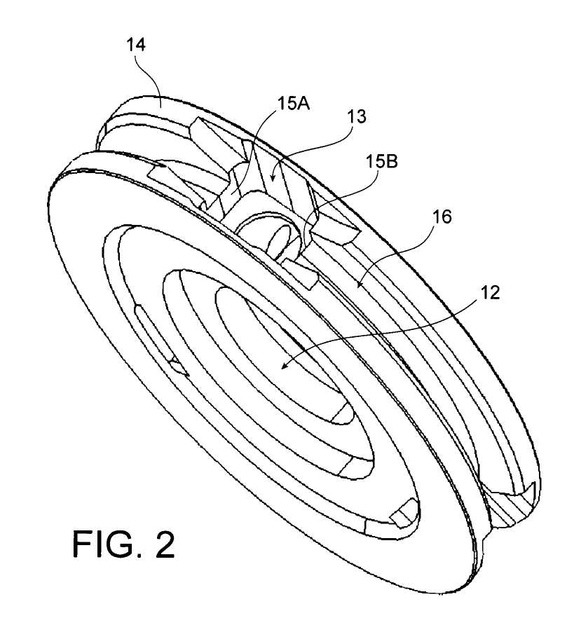

FIG. 2 shows a perspective view of a control pulley 12 of the lifting equipment according to the preferred embodiment.

The control pulley 12 is coupled to said lifting device (not shown) such that rotation of the control pulley 12 causes actuation of the lifting device. More precisely, the control pulley 12 is coupled to the lifting device through a torque reduction gear (not shown). Said reduction gear reduces the torque at the control pulley 12 and transmits it to the lifting device. Furthermore, a mechanical safety system is provided that prevents the lifted load from lowering if the control pulley 12 is not actuated.

Said control pulley 12 comprises a plurality of compartments 13 arranged at its circumferential surface 14 and spaced uniformly from each other.

Each compartment 13 is at least partially delimited by two lateral surfaces forming a stop 15A, 15B. Each surface forming a stop 15A, 15B extends approximately orthogonal to the circumferential axis of the pulley.

The compartments 13 are connected to each other by a groove 16 formed in the circumferential surface 14 of the pulley 12 that extends along the circumferential axis of the control pulley 12.

The lifting equipment comprises transmission means which, when actuated, cause rotation of the control pulley 12.

The transmission means comprise a control rope 30 to which a plurality of stop devices 40 are fixed.

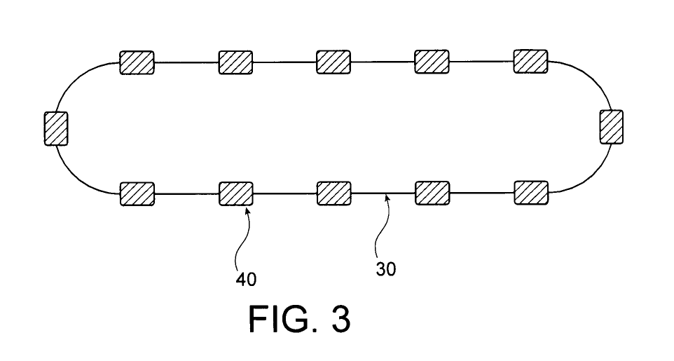

FIG. 3 shows a diagrammatic longitudinal sectional view of a control rope 30 according to the preferred embodiment of the invention, provided with said plurality of stop devices 40.

The control rope 30 is formed from an assembly of polyamide wires distributed in four strands, and has a closed length of the order of ten meters. It has a circular global cross-section. Each strand also has a circular cross-section.

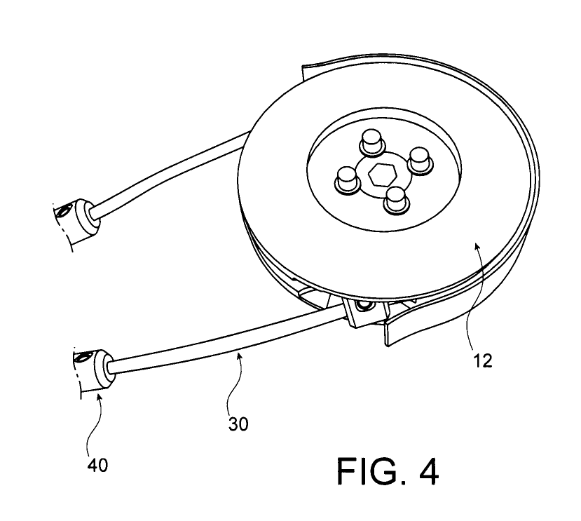

It is arranged so as to wind partly around the control pulley 12 as shown in FIG. 4 which is a perspective view of the control pulley shown in FIG. 2, on which the control rope shown in FIG. 3 winds partially.

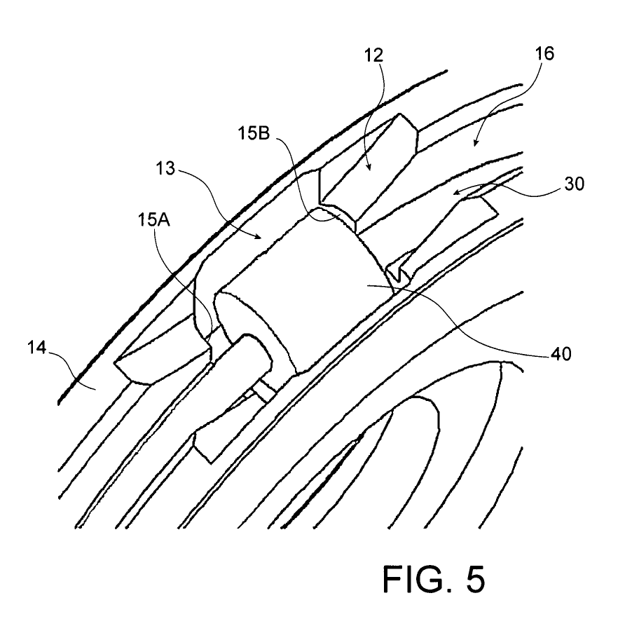

More precisely, the control rope 30 engages in a part of the groove 16 of the pulley 12 as shown in FIG. 5 which is a perspective view of part of the control pulley, of which one compartment houses a stop device.

The stop devices 40 are fixed to said control rope 30 at a uniform spacing along it.

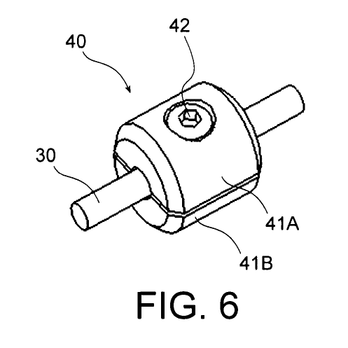

According to the preferred embodiment and as shown in FIG. 6, each stop device 40 is formed from two half shells 41A, 41B assembled to each other by attachment means.

Each half-shell 41A, 41B is in the form of a half-cylinder of revolution. The axis of revolution of the half-shells 41A, 41B coincides with the longitudinal axis of the control rope. Each is symmetric with the other about the axis of revolution.

The half-shells 41A, 41B are made from rigid PVC thermoplastic. Each has a resistance to tensile failure of between 1 and 10 daN/mm², for example 5 or 6 daN/mm².

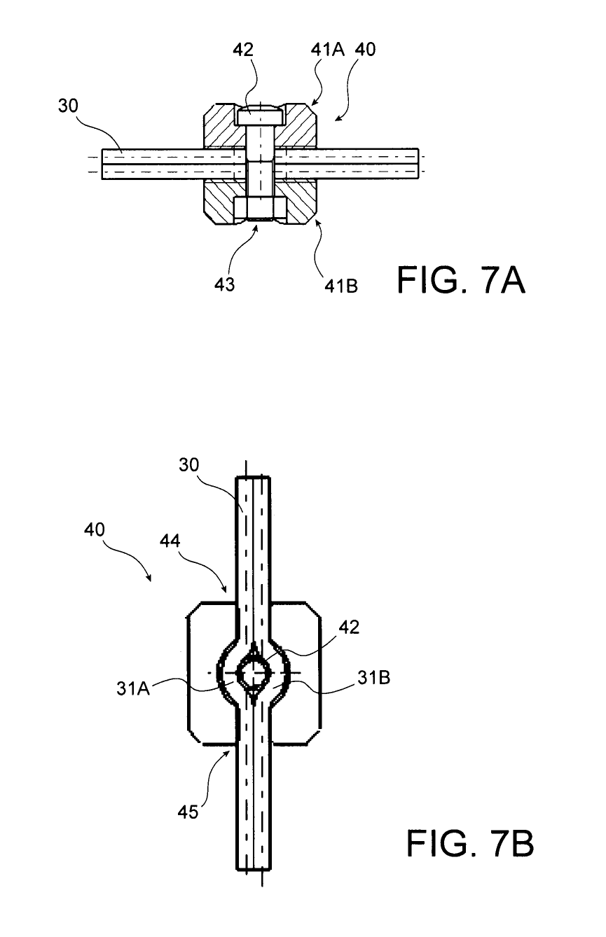

As shown in FIG. 7A, in this case the attachment means are a screw 42 and a nut 43.

The head of the screw 42 is entirely housed in counterboring formed in the outer surface of a first half-shell 41A.

The nut 43 is fully engaged in a cavity formed in the outer surface of the second half-shell 41B. The number of side faces in the cavity is the same as the number of side faces of the nut 43. For example, a hexagonal cavity houses a hexagonal nut, and prevents it from rotating.

The head of the screw 42 and the nut 43 are fully housed in their corresponding housing and therefore do not project beyond the outside contour of the half-shells 41A, 41B. They cannot come into contact with the object to be lifted or a nearby object. Any risk of damage due to them is thus eliminated.

The screw 42 extends along an axis orthogonal to the longitudinal axis of the control rope 30 and to the axis of revolution of the half-shells 41A, 41B. It extends through the control rope 30. More precisely, as shown in FIG. 7B that is a sectional view of a stop device fixed to the control rope along a plane orthogonal to the axis of the screw 42, the screw 42 passes inside a local separation between two groups of strands 31A, 31B of the rope 30. In the case of a rope with four strands, the screw 42 passes through the rope 30 such that two strands 31A pass on one side of the screw 42 and two other strands 31B pass on the other side.

The attachment means indirectly squeeze the control rope 30 by means of the half-shells 41A, 41B to prevent any displacement of the stop device 40 along the longitudinal axis of the control rope 30.

The two half-shells 41A, 41B assembled to each other by the attachment means form a cylinder, in which the internal space can contain the control rope. The diameter of said internal space at its ends 44, 45 along the axis of revolution of the two half-shells is approximately equal to the diameter of the control rope. Thus, the strands 31A, 31B of the control rope 30 are separated by the screw 42 and are then squeezed by the half-shells 41A, 41B at the ends of the inner space 44, 45 due to the squeezing force applied by the attachment means. The combination of this separation and this squeezing of the strands 31A, 31B traps the rope 30. The stop device 40 is thus prevented from translating along the longitudinal axis of the control rope 30.

In an alternative embodiment, the stop devices are made by injection moulding and may be in a similar or identical form to the half-shells described above. An insert may be provided to make the stop device rigid. The insert extends through the rope in the same way as the screw described. The rope is then trapped as described above by the combined action of separation of the strands by the insert and squeezing of the strands by the stop device at the ends of said internal space.

As shown in FIG. 5, the stop devices of the control rope that is partly wound on the control pulley engage in the compartments of said pulley.

Actuation of the transmission means effectively applies a tension force on the control rope 30. The stop devices 40 housed in the compartments 13 come into contact with the corresponding surfaces forming stops 15A, 15B. The stop devices 40 then transmit the tension force applied to the control rope 30 to the control pulley 12 which causes rotation of the control pulley.

The torque of the control pulley 12 is then reduced and transmitted to the lifting device to lift the load to be raised.

Note that the tension force may be applied in either direction along the length of the control rope. Thus, a stop device housed in a compartment on the control pulley will come into contact with one of the two surfaces forming the stop of said compartment, to transmit said tension force to the pulley and make it rotate.

Obviously, those skilled in the art could make various modifications to the invention as has been described above solely as non-limitative examples.

1-10. (canceled)

11. A mechanical assembly, comprising:
a control pulley comprising a plurality of compartments each delimited at least partially by a surface forming a stop; and
transmission means comprising:
stop devices configured to engage in the compartments, such that actuation of the transmission means will cause rotation of the control pulley, due to the stop devices engaged in the compartments coming up against corresponding surfaces forming a stop; and
a control rope made of natural and/or synthetic material fitted with the stop devices.

12. A mechanical assembly according to claim 11, wherein the control rope is formed from an assembly of threads made of a material chosen from among polyamides, polyesters, polypropylenes, and polyolefins.

13. A mechanical assembly according to claim 11, wherein the stop devices are made of a material chosen from among rubber and plastic.

14. A mechanical assembly according to claim 11, wherein each of the stop devices is fixed to the control rope through attachment means, the attachment means extending through the control rope.

15. A mechanical assembly according to claim 14, wherein the attachment means is located inside an external contour of each stop device.

16. A mechanical assembly according to claim 14, wherein each of the stop devices includes two half-shells assembled to each other by the attachment means, the attachment means inducing squeezing of the control rope between the half-shells.

17. A mechanical assembly according to claim 11, wherein the control pulley comprises a groove extending between the compartments at the circumferential surface of the pulley, the groove configured to house the control rope.

18. A lifting equipment configured to be suspended, comprising:
a lifting device configured to lift an object; and
a mechanical assembly according to claim 11, the control pulley being coupled to the lifting device such that rotation of the control pulley actuates the lifting device.

19. A lifting equipment according to claim 18, further comprising:
an assembly formed from a lifting pulley coupled to the control pulley and comprising a plurality of compartments, and a lifting rope made of a natural and/or synthetic material provided with stop devices configured to engage in the compartments of the lifting pulley; or
an assembly formed from a lifting drum and a lifting rope made of a natural and/or synthetic material, one end of the lifting rope being fixed to the drum.

20. A lifting equipment according to claim 18, wherein the control pulley is mounted to be fixed in translation relative to the lifting pulley or the lifting drum.
